(19) United States
(12) Patent Application Publication
(10) Pub. No.: US 2023/0410094 A1
(43) Pub. Date: Dec. 21, 2023

(54) System and method for Converting Multi-Media into Cryptographic Assets and Cryptographic Currency

(71) Applicant: Anthony Ferriso, Middle Village, NY (US)

(72) Inventor: Anthony Ferriso, Middle Village, NY (US)

(21) Appl. No.: 17/852,948

(22) Filed: Jun. 29, 2022

Related U.S. Application Data
(60) Provisional application No. 63/353,593, filed on Jun. 19, 2022.

(51) Int. Cl. G06Q 20/36; G06Q 20/38

(52) U.S. Cl. CPC G06Q 20/3674; G06Q 20/381; G06Q 2220/00

(57) ABSTRACT

A public computer-based system for uploading videos and minting the videos into non-fungible tokens (NFTs). The system comprises a processor and a memory associated with a web-based platform that is configured to access a plurality of objects. The web-based platform may allow a user for uploading objects through an object uploading network assembly. A network is configured for receiving video and simultaneously minting the video to NFTs and converting the proceeds into cryptographic currency. The web-based platform allows owners of Intellectual property to monetize their assets to authorize and manufacture minted NFTs. The intellectual property owner is paid in cryptographic currency. The system further comprises a crypto network creates a value for each minted non-fungible tokens (NFTs). The crypto network is configured to convert the value of each minted non-fungible tokens (NFTs) into cryptographic currency.

### CROSS-REFERENCE TO RELATED APPLICATION

This disclosure claims the benefit of the priority of U.S. Provisional Patent Application No. 63/353,593 entitled “Cryptovideos” and filed on Jun. 19, 2022. The above-identified application is incorporated herein by reference in its entirety.

### BACKGROUND

### Field of Invention

The present invention relates to distributed computing system. More particularly, to a system and method for converting multi-media into cryptographic assets and cryptographic currency.

### Description of Related Art

With the increasing expansion of decentralized finance, tokenization of all types of assets, including stock, money, debt, and real estate, has grown tremendously. Using blockchain technology, digital assets may be widely divided into fungible and non-fungible tokens (NFT). Non-fungible tokens are ones that have distinct and non-substitutable characteristics in this context. The problem with digital assets is that almost exact replicas may be made, which normally lowers the value owing to a lack of originality or uniqueness.

Cryptographic currency is a decentralized system that enables the storing, accounting, and transfer of digital value. Cryptographic currency ownership is defined by an amount of cryptographic currency located at a digital public address that is accessible via a networked device. Cryptographic currency public addresses have an associated private key that allows for the transfer of value from that address via the cryptographic currency's decentralized digital accounting ledger.

When converting any multimedia into payments, conventional systems and methods cannot execute securely. Likewise, there exist a need for a system and method for converting multi-media into cryptographic assets and cryptographic currency.

### SUMMARY

This invention describes a system and a method for converting multi-media into cryptographic assets and cryptographic currency.

An object of the present invention is to receive secure payments for the conversion of videos to non-fungible tokens (NFTs).

Embodiments in accordance with the present invention provide a system for converting multi-media into cryptographic assets and cryptographic currency. The system includes a processor and a memory associated with a web-based platform that is configured to access a plurality of objects. A multi-media server configured to store the plurality of objects associated with a user having a user account. The user associated with the user account generates a transaction request over a network using the web-based platform. A memory controller associated with the memory and the multi-media server. The memory controller is configured to receive the request for the conversion of the plurality of objects into non-fungible tokens (NFTs) on a user interface of a networked device. The non-fungible tokens (NFTs) are converted using a non-fungible token (NFT) converter. The memory controller is configured to update data and mint the non-fungible tokens (NFTs) to a wallet associated with a wallet server. The minted non-fungible tokens (NFTs) and the updated data is transmitted to the wallet connected with the wallet server over a crypto network. The crypto network creates a value for each minted non-fungible tokens (NFTs), the crypto network is configured to convert the value for each minted non-fungible tokens (NFTs) into cryptographic currency.

Embodiments in accordance with the present invention provide a method for converting multi-media into cryptographic assets and cryptographic currency. The method includes configuring a processor and associating a memory with a web-based platform that is configured to access a plurality of objects. The method also includes configuring, a multi-media server to store the plurality of objects associated with a user having a user account. Further, the user associated with each of the user account generates a transaction request over a network using the web-based platform. The method also includes associating a memory controller with the memory and the multi-media server. The memory controller is configured to receive the request for the conversion of the plurality of objects into non-fungible tokens (NFTs) on a user interface of a networked device. The non-fungible tokens (NFTs) are converted using a non-fungible token (NFT) converter. The memory controller is configured to update data and mint the non-fungible tokens (NFTs) to a wallet associated with a wallet server. The minted non-fungible tokens (NFTs) and the updated data is transmitted to the wallet connected with the wallet server over a crypto network. The method also includes creating a value for each minted non-fungible tokens (NFTs) using the crypto network. The crypto network is configured to convert the value for each minted non-fungible tokens (NFTs) into cryptographic currency.

According to an embodiment of the present invention, each account also has a cryptographic currency account server configured to receive payment, from a networked device. A user may transfer cryptographic currency to and from an external cryptographic currency account. In response to receipt of such a transfer, the cryptographic currency account server is configured to update the data pertaining to the user. The system also includes a user interface server configured to receive request from the user and conversion of video into NFT. In response to receipt of the request, the system updates the data and mints the NFT. Once the transaction request is processed, data is sent through the cryptographic currency account server associated with the crypto network which creates a value and converts the value into cryptographic currency.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a block diagram of a system for converting multi-media into cryptographic assets and cryptographic currency, according to embodiments of the present invention disclosed herein;

FIG. 2 illustrates a block diagram of a system architecture for securing non-fungible tokens (NFTs) and payment made in cryptographic currency, according to embodiments of the present invention disclosed herein;

FIG. 3 illustrates a block diagram illustrating an embodiment of the system architecture, according to embodiments of the present invention disclosed herein; and

FIG. 4 illustrates a flowchart of a method for converting multi-media into cryptographic assets and cryptographic currency, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the scope of the invention as defined in the claims.

In any embodiment described herein, the open-ended terms “comprising,” “comprises,” and the like (which are synonymous with “including,” and “having”) may be replaced by the respective partially closed phrases “consisting essentially of” consists essentially of” and the like or the respective closed phrases “consisting of” “consists of, the like.

As used herein, the singular forms “a”, “an”, and “the” designate both the singular and the plural, unless expressly stated to designate the singular only.

Blockchain functions as a public ledger where a plurality of users may independently verify data regarding the asset and, in turn, keep other users accountable. In one of the embodiments of the present invention, the blockchain records are generally unchangeable and unalterable because they are immutable records.

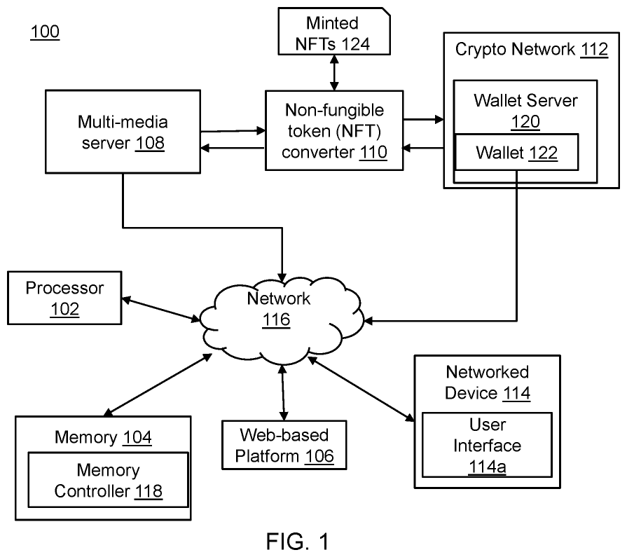

FIG. 1 illustrates a block diagram of a system 100 for converting multi-media into cryptographic assets and cryptographic currency, according to embodiments of the present invention. According to embodiments of the present invention, the cryptographic assets may comprise non-fungible tokens (NFTs) and the cryptographic currency may be a payment received by a user after conversion of NFTs. In one of the embodiments of the present invention, the NFT may be used to represent a digital or physical item virtually and be linked to a tangible object, such as collectibles and artefacts.

The system 100 comprises a processor 102, a memory 104 and a web-based platform 106, a multi-media server 108, a non-fungible token (NFT) converter 110, a crypto network 112, a networked device 114, a network 116, a memory controller 118, and a wallet server 120, according to embodiments of the present invention.

The system 100 may comprise the processor 102 and the memory 104 associated with the web-based platform 106 that may be configured to access a plurality of objects. According to embodiments of the present invention, the plurality of objects stored on the multi-media server comprises videos, a music, picture, an artwork, a game, and so forth. Embodiments of the present invention are intended to include or otherwise cover any type of the objects including known, related art, and/or later developed technologies.

According to embodiments of the present invention, the processor 102 may be, but not limited to, a Programmable Logic Control unit (PLC), a microcontroller, a microprocessor, a computing device, a development board, and so forth. Embodiments of the present invention are intended to include or otherwise cover any type of the processor 102 including known, related art, and/or later developed technologies that may be capable of processing the received data.

Further, the web-based platform 106 may be configured to enable the user to control the system 100, according to an embodiment of the present invention. According to an embodiment of the present invention, the networked device 104 may enable the user to input data for controlling the system 100. The web-based platform 106 may be further configured to display output data associated with the system 100, in an embodiment of the present invention.

In one of the embodiments of the present invention, the web-based platform 106 may be installed on the networked device 104 that may be configured to provide access to the user for controlling other components of the system 100.

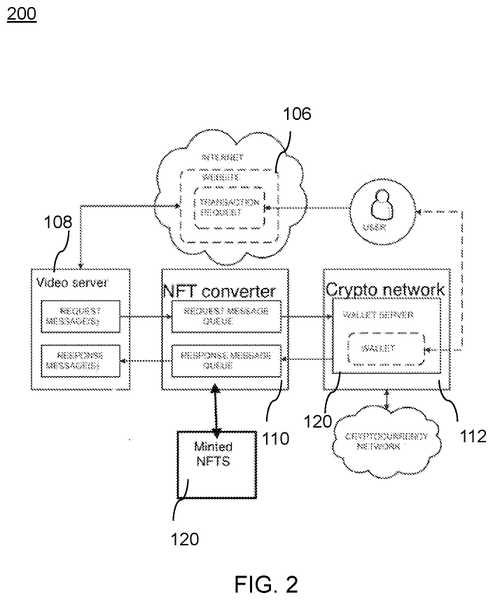

The multi-media server 108 may be configured to store the plurality of objects associated with a user having a user account. Referring to FIG. 2, the user associated with the user account generates a transaction request over the network 116 that utilizes a network interface 126 and utilizes the web-based platform 106. The multi-media server 108 may include a distributed ledger, immutable database, block-chain structure, and the like.

According to embodiments of the present invention, the network 116 may include a data network such as, but not limited to, an Internet, a Local Area Network (LAN), a Wide Area Network (WAN), a Metropolitan Area Network (MAN), and so forth. In some embodiments of the present invention, the network 116 may include a wireless network, such as, but not limited to, a cellular network and may employ various technologies including an Enhanced Data Rates for Global Evolution (EDGE), a General Packet Radio Service (GPRS), and so forth. In some embodiments of the present invention, the network 116 may include or otherwise cover networks or sub-networks, each of which may include, for example, a wired or a wireless data pathway.

The system may further utilize an intranet, such as a home or office network system, typically has the multi-media server 106 that can perform Internet communications and allows a network to be built between a number of users.

According to an embodiment of the present invention, a plurality of components presents in the system 100 may be configured to communicate with each other by one or more communication mediums connected to the communication network 116.

The communication mediums include, but are not limited to, a coaxial cable, a copper wire, a fiber optic, a wire that comprise a system bus coupled to a processor of a computing device, and so forth. Embodiments of the present invention are intended to include or otherwise cover any type of the communication mediums, including known, related art, and/or later developed technologies.

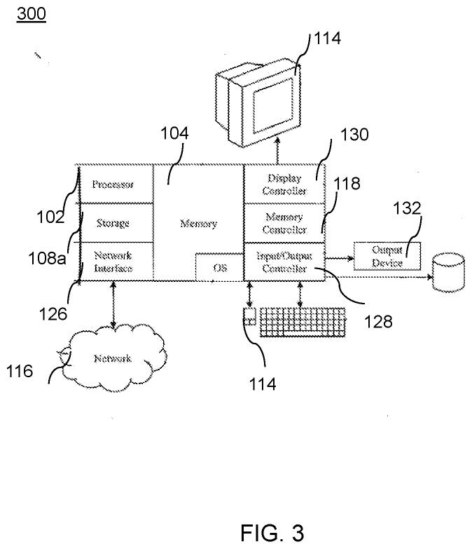

When the user sends the transaction request for the non-fungible tokens (NFTs), the request may be transmitted to the multi-media server 108 and the object being a video is retrieved. In an embodiment of the present invention, the user accesses the web-based platform 106 for objects uploading through an object uploading network assembly. According to embodiments of the present invention, the object uploading network assembly comprises a video server 108, the processor 102, a storage 108a, the memory 104, an Input and output controller 128, a display controller 130, an output device 132, and so forth, as seen in FIG. 3.

The storage 108a may include computer-readable media, including removable computer readable media, such as disks, thumb drives and the like, or disk drives, solid state memory, random access memory (RAM), read only memory (ROM) and other types of storage. The display controller 130 may control displays including an LCD display, an LED display, or other types of display devices on which video information may be displayed.

The memory controller 118 may be associated with the memory 104 and the multi-media server 108. The memory controller 118 may be configured to receive the request for the conversion of the plurality of objects into non-fungible tokens (NFTs) on the user interface 114a of the networked device 114. According to an embodiment of the present invention, the networked device 114 may be configured to enable the. user to receive data and transmit data within the system 100.

According to embodiments of the present invention, the networked device 114 may be, but not limited to, a mobile device, a smart phone, a tablet computer, a portable computer, a laptop computer, a desktop computer, a smart device, a smart watch, a smart glass, and so forth. Embodiments are intended to include or otherwise cover any type of the networked device 114, including known, related art, and/or later developed technologies.

The non-fungible tokens (NFTs) may be converted using a non-fungible token (NFT) converter 110. The networked device 114 may be configured by the web-based platform 106 using internet. Further, the networked device 114 may be configured to securely store non-fungible tokens (NFTs) owned by the user on the networked device 114, send the cryptographic currency to the wallet 122 in conjunction with data, display the cryptographic currency received in the wallet 122 using the user interface 114a and initiate a transfer of the cryptographic currency to and from the wallet 122 in response to receipt of the transaction request.

The memory controller 118 may be configured to update data and mint the non-fungible tokens (NFTs) to the wallet 122 associated with the wallet server 120. The minted non-fungible tokens (NFTs) 124 and the updated data is transmitted to the wallet 122 connected with the wallet server 120 over the crypto network 112. The crypto network 112 may create a value for each minted non-fungible tokens (NFTs) 124. The crypto network 112 may be configured to convert the attain value into cryptographic currency. In an embodiment of the present invention, the crypto network 112 may be adapted to enable cryptographic currency transactions that include one or more public or non-public communication networks. Further, the cryptographic currency payment is processed, the video is sent for conversion, NFT is minted and delivered to the user. The process is easy and seamless.

In an exemplary embodiment of the present invention, each account also has a cryptographic currency account server configured to receive payment, from a networked device 114. The user may transfer cryptographic currency to and from an external cryptographic currency account. In response to receipt of such a transfer, a cryptographic currency account server may be configured to update the data pertaining to the user. The system 100 also includes a user interface server configured to receive request from the user and conversion of video into NFT. In response to receipt of the request, the system 100 updates the data and mints the NFT. Once the transaction request is processed, data is sent through a cryptographic currency account server associated with the crypto network which create a value for a determined NFT and converts the value into cryptographic currency.

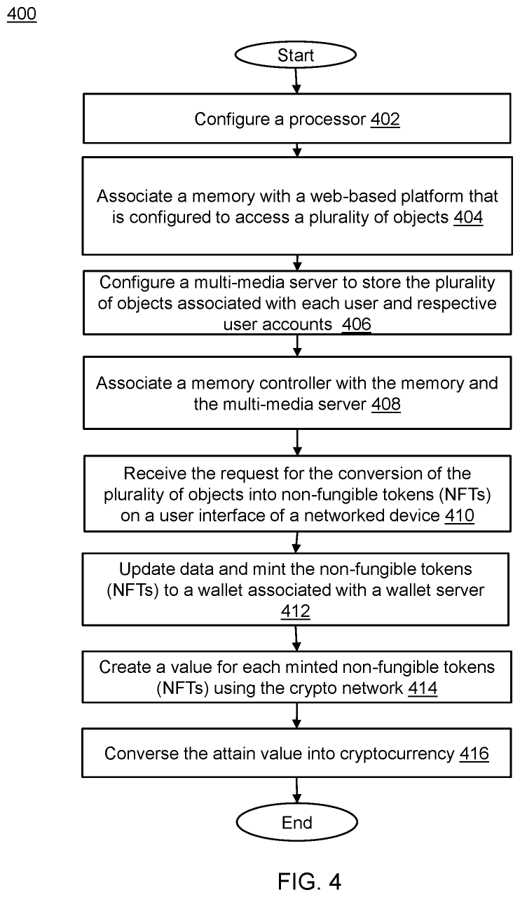

FIG. 4 illustrates a flowchart of a method for converting multi-media into cryptographic assets and cryptographic currency, according to embodiments of the present invention.

At 402, the processor 102 may be configured for processing a plurality of components associated with the system 100.

At 404, the memory 104 may be associated with the web-based platform 106 that is configured to access a plurality of objects. According to embodiments of the present invention, the plurality of objects that may be stored on the multi-media server 108 may comprise videos, a music, picture, an artwork, a game and so forth. Embodiments of the present invention are intended to include or otherwise cover any type of the objects including known, related art, and/or later developed technologies.

At 406, the multi-media server 108 may be configured to store the plurality of objects associated with the user having the user accounts. Further, the user associated with the user account generates a transaction request over a network using the web-based platform 106.

At 408, the memory controller 118 may be associated with the memory 104 and the multi-media server 108.

At 410, receive the request for the conversion of the plurality of objects into non-fungible tokens (NFTs) on the user interface 114a of the networked device 114.

At 412, update data and mint the non-fungible tokens (NFTs) to the wallet 122 associated with the wallet server 120.

At 414, the crypto network 110 creates a value for each minted non-fungible tokens (NFTs) 124.

At 416, the crypto network 110 may be configured to convert the created value for each minted non-fungible tokens (NFTs) into cryptographic currency.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed is:

1. A system for converting multi-media into cryptographic assets and cryptographic currency, the system comprising:
a processor;
a memory associated with a web-based platform that is configured to access a plurality of objects;
a multi-media server configured to store the plurality of objects associated with a user having a user account, wherein the user associated with the user account generates a transaction request over a network using the web-based platform;
a memory controller associated with the memory and the multi-media server, the memory controller is configured to:
receive the request for the conversion of the plurality of objects into non-fungible tokens (NFTs) on a user interface of a networked device, wherein the non-fungible tokens (NFTs) are converted using a non-fungible token (NFT) converter; and
update data and mint the non-fungible tokens (NFTs) to a wallet associated with a wallet server, wherein the minted non-fungible tokens (NFTs) and the updated data is transmitted to the wallet connected with the wallet server over a crypto network;
the crypto network creates a value for each minted non-fungible tokens (NFTs), the crypto network is configured to convert the created value for each minted non-fungible tokens (NFTs) into cryptographic currency.

2. The system of claim 1, wherein the plurality of objects stored on the multi-media server comprises videos, a music, picture, an artwork, a game, or any combination thereof.

3. The system of claim 1, wherein the networked device is configured by the web-based platform using internet, the networked device is configured to:
securely store non-fungible tokens (NFTs) owned by the user on the networked device;
send the cryptographic currency to the wallet in conjunction with data;
display the cryptographic currency received in the wallet using a user interface; and
initiate a transfer of the cryptographic currency to and from the wallet in response to receipt of the transaction request.

4. The system of claim 1, wherein when the user sends the transaction request for the non-fungible tokens (NFTs), the request is transmitted to the multi-media server and the object being a video is retrieved.

5. The system of claim 1, wherein an object uploading network assembly is configured for uploading and accessing the plurality of objects.

6. The system of claim 5, wherein the object uploading network assembly comprises a video server, the processor, a storage, the memory, an Input and output controller, a display controller, or any combination thereof

7. The system of claim 1, wherein the crypto network is adapted to enable cryptographic currency transactions that include one or more public or non-public communication networks.

8. A method for converting multi-media into cryptographic assets and cryptographic currency, the method comprising:
configuring, a processor;
associating, a memory with a web-based platform that is configured to access a plurality of objects;
configuring, a multi-media server to store the plurality of objects associated with a user having a user account, wherein the user associated with the user account generates a transaction request over a network using the web-based platform;
associating a memory controller with the memory and the multi-media server, the memory controller is configured to:
receive the request for the conversion of the plurality of objects into non-fungible tokens (NFTs) on a user interface of a networked device, wherein the non-fungible tokens (NFTs) are converted using a non-fungible token (NFT) converter; and
update data and mint the non-fungible tokens (NFTs) to a wallet associated with a wallet server, wherein the minted non-fungible tokens (NFTs) and the updated data is transmitted to the wallet connected with the wallet server over a crypto network;
creating a value for each minted non-fungible tokens (NFTs) using the crypto network, the crypto network is configured to convert the value of each minted non-fungible tokens (NFTs) into cryptographic currency.

9. The method of claim 8, further comprising sending the transaction request for the non-fungible tokens (NFTs) by the user, the request is transmitted to the multi-media server and the object is retrieved.

10. The method of claim 8, wherein the plurality of networked devices is configured by the web-based application using internet, the plurality of networked devices is configured to:
securely store non-fungible tokens (NFTs) owned by the user on the networked device;
send the cryptographic currency to the wallet in conjunction with data;
display the cryptographic currency received in the wallet using a user interface; and
initiate a transfer of the cryptographic currency to and from the wallet in response to receipt of the transaction request.
